(19) United States
(12) Patent Application Publication
(10) Pub. No.: US 2011/0281084 A1
(43) Pub. Date: Nov. 17, 2011

(54) VARIABLE BOND STRENGTH ADHESIVE TAPE

(76) Inventor: Tim Ashwell, Canandaigua, NY (US)

(21) Appl. No.: 12/780,700

(22) Filed: May 14, 2010

(51) Int. Cl. C09J 7/02

(52) U.S. Cl. 428/195.1

(57) ABSTRACT

A medical adhesive tape in which a number of bare spots are provided through the tape to vary the strength of the bond of the tape to a surface. The number of bare spots as well as their size and location can be varied to modify the adhesive strength with which the tape is held onto the patient.

### BACKGROUND

1. Technical Field

This description generally relates to the field of adhesive tapes and, more particularly, to the field of medical adhesive tapes.

2. Description of the Related Art

Adhesive tape is widely used in many fields, including medical, industrial, fastener, painting and other technology areas. The types of adhesive tape range from duct tape to masking tape to packing tape to medical tape and many types in addition to these. Often, it is desired to select the amount of strength with which the adhesive tape is bonded to a surface. This could be referred to as the stickiness of the adhesive tape, namely the strength of the bond of the tape to the surface to which it is adhered.

After medical tape has been applied to a patient, the removal of that tape can sometimes be painful. Often, a patient's hair may stick to the tape, and removal of the tape will pull the hair out of the patient's skin, causing pain, and in some cases is sufficient to see such an apprehension in the patient that they leave the tape on for extended periods of time when it should have been removed. In some patients, the apprehension and the actual pain would be sufficiently great that they pull or jerk as the tape is removed, further exacerbating the injury. While it is desirable to have the medical tape of sufficient strength that it performs the medical function, such as holding the bandage on the wound, taping a lead to a person's chest, or supporting a limb in the correct position, it is desirable that the adhesive tape itself not cause additional pain or injury to the patient.

Currently, the strength of an adhesive tape is varied by changing the type of adhesive. For example, duct tape uses a first type of adhesive and painters tape uses a different adhesive strength which is much lower in strength. This ensures that the painters tape will not damage the surface on which it is taped and, upon removal, will not lift off any paint underneath it. Different types of medical tape also have different gripping strengths, which is varies depending on the type of adhesive used on the medical tape. Varying the type of adhesive from one tape to another is quite expensive and requires different chemical formulations. In addition, all of the tapes look the same to the user and only after the tape has been adhered does the user learn whether or not they have selected a tape with a high adhesive value or a low adhesive value.

### BRIEF SUMMARY

According to principles of the embodiment described herein, tape is provided whose adhesive strength can be varied easily based on the surface area of the adhesive on the tape itself. A plurality of bare spots in the adhesive are provided on the tape. The adhesive strength of the tape is varied based on a number of factors including the number of bare spots, the size of the bare spots, the shape of the bare spots, and their location on the tape. The bare spots referred to in this instance are only through the adhesive. It is a spot or zone where no adhesive is applied to the tape. It is not a hole in the tape itself, rather a location on the tape to which no adhesive is applied.

In one embodiment, the number of bare spots per square inch is a constant, for example five bare spots per square inch of tape. The size of the bare spots can vary from small, namely less than a millimeter in diameter to large, for example up to a centimeter or larger in diameter. In this embodiment, the number of bare spots is constant, but the size of the bare spot changes. Accordingly, the surface area will vary, decreasing the overall strength of the adhesive tape to the surface for larger bare spots.

In another embodiment, the number of bare spots per square inch is varied. In a first embodiment, the number of bare spots per square inch may be in the range of five or six. If it is desired to decrease the adhesive strength of the tape, the number of bare spots can be increased, for example to be in the range of 25 bare spots per square inch, or reduced, for example to in the range of two or three per square inch.

In a further embodiment, the shape of the bare spots can be modified. For example, the strongest adhesive force remains if the bare spot is a circle. The shape of the bare spot could be modified to be an oval, which will slightly decrease the adhesive strength, or a diamond, triangle, or other geometric shapes.

In a further embodiment, the location of the bare spots on the adhesive tape can be selected to modify the adhesive strength. Specifically, if the bare spot overlaps an edge of the adhesive tape, then the adhesive strength of the tape to an object is substantially reduced. Because a large amount of the adhesive strength is based on seal at the edge, by placing the bare spots to overlap the edge, the adhesive strength can be substantially reduced while keeping the same number of bare spots per square inch or the same size of bare spots. Accordingly, by varying the combination of the number of bare spots, the size of the bare spots, their respective shapes, and whether or not the bare spots overlap an edge of the tape, the strength of the adhesive tape to a surface can be selected to vary greatly over a wide range, in each instance using the same adhesive compound and the same backing for the tape. The embodiments provide the advantage that a single tape can be provided with the same backing material and the same chemically formulated adhesive and, based on the bare spots formed in the tape, the strength with which the adhesive tape adheres to a surface can be modified to vary over a wide range.

### BRIEF DESCRIPTION OF THE SEVERAL VIEWS OF THE DRAWINGS

FIG. 1 is a top plan view of adhesive tape having bare spots therein according to one embodiment of the present invention.

FIG. 2 is a second embodiment having the same number of bare spots per square inch as FIG. 1.

FIG. 3 is an alternative embodiment having a larger number of bare spots per square inch.

FIG. 4 is a further embodiment having the same number of bare spots of FIG. 1, but having a different shape to modify the adhesive strength.

FIG. 5 illustrates a further embodiment in which the bare spots overlap the edges of the tape.

FIG. 6 illustrates a further embodiment in which the bare spots have a diamond shape and a plurality of them overlap the edges of the tape.

FIG. 7 illustrates a further embodiment in which there are fewer bare spots, but some of which overlap the edges of the tape.

FIG. 8 illustrates a modified shape of the tape in which the bare spots have a geometric shape whose orientation varies across the tape.

FIG. 9 illustrates a further embodiment in which the bare spots do not not have uniform density on the entire tape.

### DETAILED DESCRIPTION

FIG. 1 illustrates a variable bond strength adhesive tape 10 in accordance with one embodiment of the invention. The embodiment of FIG. 1 includes a backing material 12 with an adhesive film on one side. In one embodiment the backing material is a polymeric film that is tough and flexible. In a further embodiment, the backing material is resistant to tearing. In still a further embodiment, the backing material is receptive to cutting and ease of perforation, so that the backing material can be made into a variety of shapes.

The adhesive film on one side of the backing is any one of a number of adhesive films well known in the art. Many acceptable adhesives are well known in the art. The invention will be most useful in the medical arts in which it is desirable to affix medical adhesive tape to a patient with varying levels of stickiness. Therefore, a preferred adhesive film is of the type which is biocompatible and which is currently used on medical tape. Because the application of an adhesive film to backing to make adhesive tape is well known in the art, the details of the adhesive film and the tape are not shown and any of the current techniques which are used in the art are acceptable for making the adhesive tape of the present invention. The adhesive film provides the backing material with adhesiveness on one side, so that the backing material has the ability to adhere to solid surfaces when the adhesive-backed side is pressed against the solid surface. In one embodiment, the backing material and the adhesive film are compatible with human skin, and in one application the backing material is adhered to the human skin by the adhesive film.

In accordance with one embodiment of the invention, a plurality of bare spots 14 are in the adhesive film. The bare spots 14 are holes that extend completely through the adhesive layer on the tape. The bare spots 14 can therefore be considered apertures, perforations, holes, or the like in the adhesive layer on the tape. The bare spots 14 can be made by any acceptable technique including being made when the adhesive layer is first formed on the strip tape as it is being manufactured, or by perforations in the completed tape as it is rolled onto the roles for use or at any acceptable time in the manufacturing process. In one embodiment, the mask is provided on the backing layer as the adhesive is applied to the tape. The mask blocks the application of the adhesive to the tape so that when the adhesive is applied, it is missing from the spots which are selected to be bare spots. For example, a stencil is positioned between the adhesive film application and the backing for the tape to prevent the adhesive from being applied to the tape at selected locations.

In another embodiment, the adhesive can be applied from a nozzle or series of nozzles to be applied at certain locations but not others. Any acceptable way to place the adhesive on the tape while leaving bare spots on the tape backing may be used.

In one embodiment the bare spots 14 are round and distributed across the backing material and adhesive film in a grid-like pattern. In one embodiment of the invention, the size of the bare spots 14 is selected so that the cumulative area of the bare spots 14 occupies a selected portion of the overall area of the backing material on a per unit area basis.

In the embodiment shown in FIG. 1, there are approximately 5.5 bare spots per square inch of adhesive tape and the location of the bare spots 14 is spaced to be at least the size of one bare spot away from any edge. Namely, each bare spot 14 is spaced away from an edge 16 of the adhesive tape by a distance greater than the diameter of the bare spot 14 itself. This ensures that the presence of the bare spot 14 will not interfere with the sealing edge 16 of the adhesive tape 10, however, it will modify the overall holding strength of the adhesive tape as a whole.

Based on the number of bare spots 14 and the size of the bare spots 14 shown in FIG. 1, approximately 25% of the surface of the tape has been removed by the presence of the bare spots 14. Accordingly, the overall adhesive strength of the tape 10 will be reduced 25% once the tape starts to be removed.

According to a first embodiment, the tape is provided on a roll similar to standard medical tape. When the user desires to use the tape, he selects the tape having the preferred number of bare spots or reduce reduced adhesive surface area, unrolls the tape and applies it to the skin of the patient as standard medical tape. He may tear or cut the medical tape at any desired location along the roll and since the bare spots have a uniform density along the entire length of the roll of tape, the user can be assured that the grip will have the expected properties.

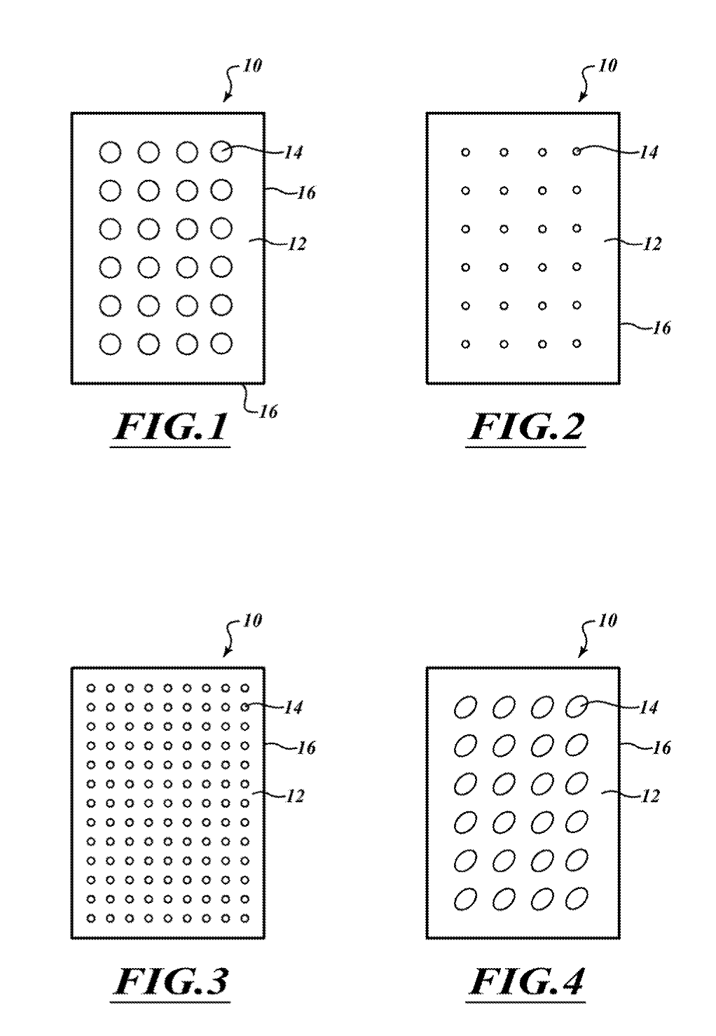

FIG. 2 shows another embodiment of the invention having round bare spots 14 distributed over the backing material in the same density and pattern as in FIG. 1, but in which the bare spot size is smaller than in the embodiment of FIG. 1. In a comparison of the bond strength of the embodiments of FIGS. 1 and 2, the embodiment of FIG. 2 has greater bond strength due to greater adhesive area as a fraction of the overall area on a per unit area basis. In the embodiment of FIG. 2, the same number of bare spots 14 per square inch is used as in the embodiment of FIG. 1, namely, approximately five bare spots per square inch. However, because the size of the bare spots 14 is smaller, the adhesive strength will substantially increase. In the embodiment of FIG. 2, the bare spots 14 comprise about 5% of the surface area of the adhesive tape. In one embodiment of the invention, the bond strength of the tape is selectable based on the number of the bare spots 14 through the backing material and the adhesive film.

FIG. 3 shows another embodiment of the invention in which the bare spots 14 are of the same size and shape as in the embodiment of FIG. 2, but the density is much higher. In a comparison of the bond strength of the embodiments of FIGS. 2 and 3, the embodiment of FIG. 2 has greater bond strength due to greater adhesive area as a fraction of the overall area on a per unit area basis. In a further embodiment of the invention, the bond strength of the tape is selectable based on the density of the bare spots 14 through the backing material and adhesive film on a per unit area.

For example, in the embodiment of FIG. 3, the density may be in the range of 25 to 30 bare spots 14 per square inch as compared to approximately 5 bare spots per square inch for the embodiment of FIGS. 1 and 2. Of course, the number of bare spots 14 per square inch can be varied over a range from as few as 1 or 2 bare spots per square inch to in excess of 50 bare spots per square inch.

FIG. 4 shows another embodiment of the invention in which the bare spots 14 are non-circular. In one embodiment of the invention, the adhesive area as a fraction of the overall area on a per unit area basis is selectable based on the shape of the bare spot 14 through the backing material and the adhesive film.

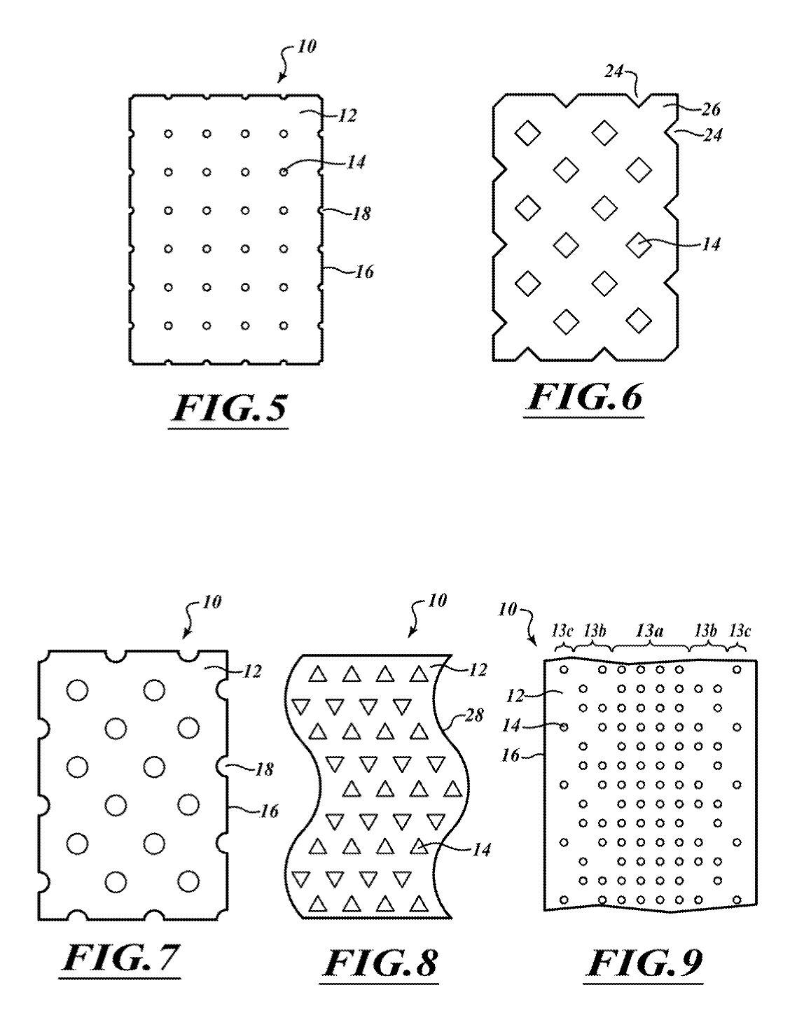

FIG. 5 shows another embodiment of the invention in which the round bare spots 14 distributed over the backing material 12 in the same grid-like pattern intersect a perimeter edge 16 of the backing material 12 and the adhesive film 10. Specifically, some of the bare spots 14 are located at edge 16 and thus form edge bare spots 18. An edge bare spot 18 may be considered a recess or indentation in the edge, however, it is preferably made by the same technique as the other bare spots 14 and the alignment of the tape and the machine making the bare spots is selected to ensure that a number of bare spots overlap with the perimeter edge 16. When an edge 16 has a plurality of bare spots 14 at the edge, the sealing force of the edge varies greatly as compared to an edge which has no bare spots thereon. In addition, the shape of the bare spot at the perimeter edge 16 has a substantial influence on the adhesive force of the tape as a whole. For example, circular bare spots 18 would have a first sealing ability as compared to other shapes such as squares, diamonds, triangles, and other bare spot shapes which overlap with the perimeter. In this embodiment, the effect of the bare spots 14 on the perimeter edge 16 of the tape influence the bond strength of the tape. In this embodiment, the size of the bare spots 14, the density of the bare spots 14, and the edge effects of the perimeter bare spots 14 combine to determine the bond strength of the adhesive tape.

FIG. 6 shows still another embodiment in which the bare spots 14 are squares in a grid-like pattern diagonal to the perimeter edge of the backing material. As in the embodiment of FIG. 5, the bare spots 14 intersect the edge and, therefore, the bond strength is a function of at least one of the bare spot size, the bare spot density, the bare spot shape, and perimeter edge effects. Because the shape of bare spot in FIG. 6 is in a diamond or square shape, the effect on the perimeter will be substantially greater than a circular bare spot, and the sealing strength at the perimeter edge will be reduced greater than it would be reduced for a circular bare spot.

In addition, the location of the bare spots along the edge, whether at a corner or other location, will affect the strength of the tape at that particular location. As shown in the embodiment of FIG. 6, two bare spots 24 may be closely adjacent to a particular edge 26, providing a substantially reduced strength at that particular edge location 26. Thereafter, when a medical practitioner such as a nurse or doctor removes the medical tape, they may start at the edge 26 which has reduced adherence and can more easily begin the removal of the tape at this location. A pattern of bare spots 14 can be selected which ensures that when the tape is applied, if it is torn at a selected location, bare spots will occur naturally under the edges in order to provide an easy lift location 26 for later removal of the tape.

FIG. 7 shows yet another embodiment in which the bare spots 14 are round, distributed in a grid-like pattern diagonal to the perimeter edge, and in which the bare spots 14 intersect the perimeter edge. In this embodiment, the bond strength is selectable according to at least one of the bare spot size, the bare spot density, and the perimeter edge effects.

FIG. 8 shows still another embodiment in which the bare spots 14 are triangular and distributed in offset rows, and in which the perimeter edges of the backing material and the adhesive film are curved edges 28. In this embodiment, the bond strength is selectable based on at least one of the size, shape, and density of the bare spots 14 and on the shape of the perimeter edges.

FIG. 9 illustrates an embodiment in which the pattern of the bare spots 14 varies across the width of the tape. In many instances for medical tape, it is desired to have the edge have a tight seal to bond closely to the skin and prevent dirt from getting under the tape. However, once the edge 16 has been released, it may be desired to have the central portion of the tape remove more easily so as to avoid pulling hairs or having excessive stickiness over the wound. Accordingly, in the embodiment of FIG. 9 the bare spots are arranged in zones across the roll of tape. An outermost zone 13c which is adjacent to an edge of tape, has a very low density of bare spots 14. Toward a more central zone, such as 13b, the density of the bare spots increase slightly. The zone 13b still provides a high adhesive strength, however, it will be slightly reduced as the number of holes in that region is slightly increased. In the central region 13a, the number of bare spots is greatly increased to substantially reduce the amount of adhesive strength in this central portion.

The embodiment of FIG. 9 provides the advantage of substantial adhesive strength at the edges and good holding of the tape while permitting easy removal once the tape has started to be removed. In many instances, the most difficult part of removing an adhesive tape is in the central portion, after its edge has been lifted and it is being has begun to be pealed away from the skin. The embodiment of FIG. 9 therefore provides reduced adhesive strength in the central region which heretofore has been the most painful and troubling portion of medical tape removal.

Of course, in the embodiment of FIG. 9, the strength of the adhesive tape can be varied by varying the size of the bare spots in the various zones of the tape. For example, the bare spots in the edge zone 13c may be relatively small whereas the bare spots in the central zone 13a may be relatively large. In addition, it may be desired to have no bare spots in the outer edge 13c and have bare spots only in the middle zone 13b and bare spots in the central zone 13a. The relative size of the zones as well as the number of bare spots and their relative size can be varied to provide an adhesive strength that varies across the width of the tape.

In one embodiment of the invention, an adhesive tape dispenser holds a plurality of tape rolls ready for dispensing. Each tape roll is made up of the same backing material and adhesive film, but varies in the size, shape and density of the bare spots 14 through the backing material and adhesive film, making the bond strength of each roll unique from the others.

An alternative way to provide the bare spots on the tape is to form perforations or apertures through the tape itself. According to this alternative embodiment, the apertures extend completely through the tape, removing both the backing material and adhesive where the aperture is present. This will, of course, reduce the adhesive strength of the tape since there will be no adhesive where the perforations are present. The perforations can be made by any acceptable technique, such as spikes, pins, punches or the like after the final tape is made. The perforations in the backing material can be made before or after the adhesive material is applied to the backing layer of the tape.

One benefit of using bare spots instead of apertures completely through the tape is that the mechanical strength of the tape will remain the same, with no reductions in strength, rather only the stickiness of the tape will be reduced. Thus, with the bare sports present, the tape will not rip or tear more easily, but, when it is peeled away from the skin, it can be more easily removed because the adhesive strength will be reduced based on the surface area and shape of the bare sports, as explained herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An adhesive tape, comprising:
a backing material;
an adhesive film at selected locations on one side of the backing material; and
bare spots on the backing material at which no adhesive film is present, a bond strength of the backing material to a contact surface selectable based on at least one of size and density of the bare spots on a per unit area basis.

2. The adhesive tape of claim 1 wherein the bond strength is further selectable based on the shape of the bare spots.
